(19) United States
(12) Patent Application Publication
(10) Pub. No.: US 2007/0139651 A1
(43) Pub. Date: Jun. 21, 2007

(54) Miniature optical beam recombiner using polarization maintaining fibers

(76) Inventor: Carol J. Courville, San Jose, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/315,461

(22) Filed: Dec. 21, 2005

(51) Int. Cl. G01J 4/00; G02B 27/10; G02B 6/26

(52) U.S. Cl. 356/364; 359/618; 385/39

(57) ABSTRACT

A miniaturized optical beam recombiner combines beams from two optical fibers while maintaining the individual polarization mode.

### BACKGROUND

Optical heterodyne interferometry used in high precision metrology is sensitive to environmental disturbances, e.g. heat. Heat reduces the measurement precision through thermal material expansion and changing the index of refraction of the air. One technique to decrease sensitivity is using optical fibers to deliver the two requisite orthogonally polarized, frequency differentiated light beams from a remotely positioned light source to the measurement area. Polarization maintaining fiber does a reasonable job of maintaining the polarization state of the fiber, but the polarization state exiting the fiber is usually not pure enough to use in high precision interferometery. Thus, the frequency and polarization differentiated light beams are typically launched down separate fibers so that each polarization can easily be restored to a pure state before entering the interferometer or before recombination into a single collinear, co-bore beam at the remote site.

In one prior art solution, “Active Control and Detection of Two Nearly Orthogonal Polarizations in a Fiber for Heterodyne Interferometry,” U.S. Ser. No. 11/156,103, filed 17 Jun. 2005, assigned to Agilent Technologies, Inc., the aformentioned problem is addressed by transmitting the 2 polarizations along a single optical fiber while dynamically adjusting polarization mixing by controlling the polarization entering the fiber. While this method is effective, if the polarization changes too quickly, the required polarization purity can not be attained for ultra high accuracy applications.

In another prior art solution, Z4204A, offered by Agilent Technologies, Inc. the two fiber recombination at the remote location occurs using bulk optics, e.g. two fibers terminated with collimators, two sets of wedge windows for steering the beams, and a Rochon prism. The multiple piece bulk optic components are large.

In another prior art solution, one polarization is transmitted along a single optical fiber. The second frequency and polarization is generated at the measurement location. This solution often uses an acousto-optic modulator (AOM) as the frequency generation source. The AOM is bulky and introduces a heat source in the metrology area.

### SUMMARY OF THE INVENTION

A miniature optical beam recombiner combines beams from two optical fibers in a lightweight and compact package. The recombiner may further be used in a measurement system.

Further features and advantages of the present invention, as well as the structure and operation of preferred embodiments of the present invention, are described in detail below with reference to the accompanying exemplary drawings.

### BRIEF DESCRIPTION OF THE DRAWINGS

FIG. 1 illustrates a system of the present invention.

FIG. 2 illustrates an optical recombiner of the present invention.

### DETAILED DESCRIPTION

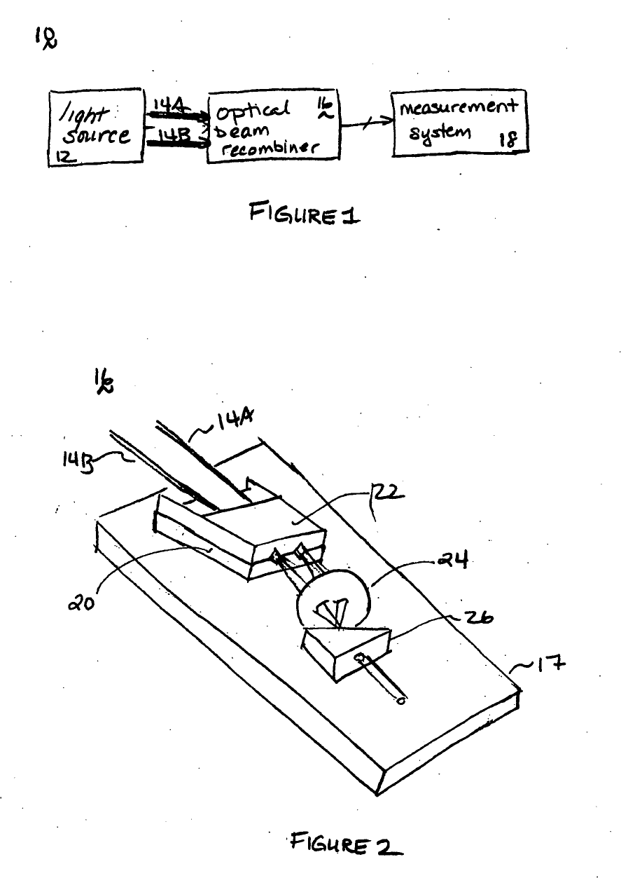

FIG. 1 illustrates a system 10 of the present invention. A light source 12 connects to two polarization maintaining fibers 14A, 14B. An optical recombiner 16 receives both polarization maintaining fibers 14A, 14B. A measurement system 18, e.g. an interferometer, receives the output of optical recombiner 16.

The light source 12 has been positioned such that no heat is transferred to the air or the downstream components.

FIG. 2 illustrates an embodiment of the optical recombiner 16 shown in FIG. 1 that is assembled on a substrate 17. The two polarization maintaining fibers 14A, 14B are terminated on a plate 20 having a V-groove. The fibers 14A, 14B are silica and the polarization is maintained by either the shape of the core of the imbedded stressor elements. Fujikura, Bow Tie and Elliptical core are illustrative examples of commonly available fibers. The plate 20 is angle polished, e.g. 8 degrees, to prevent back reflections to the laser. The plate 20 is made of glass or silica. The fibers 14A, 14B are oriented such that the polarizations of the beams are approximately orthogonal when exiting the fibers. Precise alignment of polarizations is unnecessary.

The fibers 14A, 14B are held in place with a cover plate 22 and adhesive (not shown). Alternatively, solder may be applied to the metallized coating on the fiber and in the v grooves.

In this illustrative embodiment, the V-grooves are the channels that the fibers sit in. The grooves determine the spacing of the fibers. Alternatively, in lieu of the v grooves, round cylinders, e.g. ceramic or glass with two holes drilled in them for fibers, may be used.

A positive lens 24 is positioned with respect to the v-groove plate so that the two fiber tips are located on the focal plane of the lens. The result for a point source of light situated at the back focal length of the lens is collimated light exiting the lens. Each beam is collimated by the lens but the two beams are convergent with respect to each other because there is a distance between the two fibers and neither one lies on the optic axis of the lens (beams exiting the fibers are centered with respect to lens optic axis). The two beams will cross in front of the lens.

Next, a birefringent prism 26 is placed in the path of both beams. The prism 26 cleans up the polarization of the beams exiting from each fiber as any light in the wrong polarization is sent in a different direction by the prism. The prism 26 redirects the beams so that they are collinear. When the birefringent prism 26 is placed at the beam intersection, e.g. near the front focal length, the beams can also be made to co-bore. Tolerances in the spacing of the fibers, focal length of the lens, and apex angle of the prism can be compensated for by the yaw of the prism and translation of the prism along the beam propagation axis.

Alternatively, the prism 26 may be positioned further down the beam propagation path for any desired beam separation when co-bore. beams are not required.

Although the present invention has been described in detail with reference to particular embodiments, persons possessing ordinary skill in the art to which this invention pertains will appreciate that various modifications and enhancements may be made without departing from the spirit and scope of the claims that follow.

1. An optical recombiner for use with two polarization maintaining fibers comprising:
a substrate;
a fastening mechanism, positioning the two polarization maintaining fibers proximate to the substrate;
a positive lens arrangement, positioned proximate to the ends of the fibers such that the ends are at the focal length of the lens; and
a birefringent prism receiving the collinear beams.

2. An optical recombiner, as in claim 1, the fastening mechanism comprising:
a plate having in the v-grooves, wherein the ends of the two polarization maintaining fibers lay in the v-grooves;
a cover plate, positioned over the plate such that the fibers are immovable; and
adherent material interposing the plate and cover plate.

3. An optical recombiner, as in claim 2, the adherent being selected from a group including glue and solder.

4. An optical recombiner, as in claim 1, the fastening mechanism comprising a block having two bores, each bore receiving an end of one of the two polarization maintaining fibers.

5. An optical recombiner as in claim 1, the plate being angle polished to minimize back reflections into the two optical fibers.

6. A system using two polarization maintaining fibers comprising
a light source emitting a beam;
two optical fibers, each receiving the beam, each outputting a unique polarization;
an optical recombiner receiving the two optical fibers, having an output; and
a measurement analyzer receiving the optical recombiner output.

7. A system, as in claim 6, the optical recombiner for use with two polarization maintaining fibers comprising:
a substrate;
a fastening mechanism, positioning the two polarization maintaining fibers proximate to the substrate;
a positive lens arrangement, positioned proximate to the ends of the fibers such that the ends are at the focal length of the lens; and
a birefringent prism receiving the collinear beams.

8. An optical recombiner, as in claim 7, the fastening mechanism comprising:
a plate having in the v-grooves, wherein the ends of the two polarization maintaining fibers lay in the v-grooves;
a cover plate, positioned over the plate such that the fibers are immovable; and
adherent interposing the plate and cover plate.

9. An optical recombiner, as in claim 8, the adherent being selected from a group including glue and solder.

10. An optical recombiner, as in claim 7, the fastening mechanism comprising a block having two bores, each bore receiving an end of one of the two polarization maintaining fibers.

11. An optical recombiner as in claim 7, the plate being angle polished to minimize back reflections into the two optical fibers.
